(19) United States
(12) Patent Application Publication
(10) Pub. No.: US 2003/0204525 A1
(43) Pub. Date: Oct. 30, 2003

(54) Application control method, and implementation device and processing program for the same

(75) Inventors: Naotsugu Toume, Yokohama (JP); Tetsuya Hashimoto, Tokyo (JP); Jun Yoshida, Kawasaki (JP); Yuji Yamamoto, Yokohama (JP); Nobuyuki Yamamoto, Yokohama (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/353,118

(22) Filed: Jan. 27, 2003

(30) Foreign Application Priority Data
Apr. 25, 2002 (JP) 2002-124510

(51) Int. Cl. G06F 17/00

(52) U.S. Cl. 707/103 R

(57) ABSTRACT

An application control method to control operations of applications by solving logical names described by development descriptors is provided. The method includes at least the step to create an allocation list that indicates allocation rules to allocate physical values to logical names described in applications, and the step to allocate physical values to the logical names described in the executed application according to an application status and the allocation rules in the allocation list.

### BACKGROUND OF THE INVENTION

1. Field of the Invention

The present invention relates to information processors that control operations of applications, and more particularly to a technology that is effective when applied to information processors that control operations of applications by solving logical names described by development descriptors.

2. Related Background Art

In recent years, there have been increased demands for quick development, reduction of development costs and higher quality with regard to enterprise applications in order to achieve high profit and early introduction of business models into the market. To meet these demands, application execution platforms that enhance the reusability of applications are quickly becoming widespread.

In order to enhance the reusability of applications, there are mechanisms in place in such application execution platforms to allow applications to be executed in a plurality of execution environments without having to modify programs included in the applications.

In other words, an application refers to information that varies by execution environment, such as filenames to output logs or database management server names, using logical names, which are abstract names; the application execution platform sends to the application specific physical values, such as actual filenames to output logs or actual database management server names, that are allocated in advance to logical names. Each physical value allocated to each logical name is designated by an administrator depending on the execution environment when the execution environment for the application is constructed, and only one physical value is allocated to each logical name when the applicable application is developed.

A method to develop applications on application execution platforms using development descriptors that each contains a declaration of a logical name is known. In such a method, application execution platforms are called platform servers, logical names are called environment entry names, and physical values are called environment entry values.

Application execution platforms that enhance the reusability of applications are described in chapters 1 and 2 (pages 1-16) and chapter 5 (pages 49-72) of Java 2 Platform, Enterprise Edition Specification, v. 1.3 (2001) (hereinafter called “J2EE”) published by Sun Microsystems; in this literature, application execution platforms are called J2EE platforms, application packages are called enterprise archive format files, programs that comprise applications are called components, development tools are called deployment tools, development descriptors are called deployment descriptors, logical names are called environment entry names, and physical values are called environment entry values.

Among applications executed on application execution platforms, some applications switch physical values that are used for processing depending on the application execution status, such as the user using the application or the current time.

For example, there are applications that improve the readability of logs by dividing files to output a log for each user, applications that switch files to output a log for each user in order to avoid lower performance resulting from concentration of access on one log file, applications that switch their database management servers to substitute servers during maintenance periods when the database management servers stop providing services, and the like. A processing to determine the execution status and switch the physical value accordingly is included in each of the programs of these applications.

In the conventional J2EE platform technology, due to the fact that only one physical value is allocated to each logical name when an application is developed, applications that switch physical values depending on the execution status cannot be realized using logical names. Consequently, in order to realize applications that switch physical values depending on the execution status, a processing to determine the execution status and switch the physical value accordingly must be included in application programs. However, when using such programs in environments with different status for switching physical values or with different physical values to be switched, the programs must be modified. As a result, applications cannot be reused in different execution environments.

### SUMMARY OF THE INVENTION

The present invention relates to a technology that solves the problem described above and that would allow applications that switch physical values depending on the execution status to be reusable in different execution environments.

In information processors that control operations of applications by solving logical names described by development descriptors, the present invention controls the operations of applications by allocating physical values to logical names according to application status and predetermined allocation rules.

In an information processor in accordance with an embodiment of the present invention, when an application whose logical names of the application are described by development descriptors is developed on its execution platform to be executed, an allocation list that stores the following is created: parameters representing a plurality of logical names described in the application, allocation rules indicating rules for allocating physical values to parameters, and a physical value table indicating physical values to be allocated according to application status and allocation rules.

When the application whose logical names are described by development descriptors is executed, parameters that correspond to the logical names are checked, the allocation list is referred to in order to read the allocation rules corresponding to the parameters, a status information management table that indicates the execution status of the application is referred to, physical values are read from the physical value table according to the execution status and the allocation rules, and the physical values are allocated to the logical names.

In the conventional technology, physical values allocated to logical names are constants, but in the present invention a parameter, which is a variable whose value varies every time an applicable application is executed, is correlated to each logical name, and a physical value is allocated to each parameter. By doing this, applications that switch physical values depending on the execution status can be realized using logical names. As a result, applications can be reused without any modifications even in environments with different status for switching physical values or with different physical values to be allocated.

As described above, in information processors according to the present invention, due to the fact that operations of applications are controlled by allocating physical values to logical names according to application status and predetermined allocation rules, applications that switch physical values depending on the execution status can be made reusable in different execution environments.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows an overall view of an application control according to one embodiment.

FIG. 2 shows an overall view of a conventional application execution platform.

FIG. 3 shows an overall configuration of an information processor that controls applications according to the embodiment.

FIG. 4 shows an example of a repository and lists of a parameter allocation editing tool 112 of the embodiment.

FIG. 5 shows a flowchart indicating the processing procedure of a processing to create parameter allocation according to the embodiment.

FIG. 6 shows a flowchart indicating the processing procedure of a parameter allocation editing processing according to the embodiment.

FIG. 7 shows an example of a status information management table 127 according to the embodiment.

FIG. 8 shows a flowchart indicating the processing procedure of a parameter solving processing according to the embodiment.

FIG. 9 shows an overall view of an application control without using parameters according to another embodiment.

### DESCRIPTION OF PREFERRED EMBODIMENTS

Next, an information processing apparatus that controls operations of applications by solving logical names described by development descriptors in accordance with an embodiment of the present invention is described below.

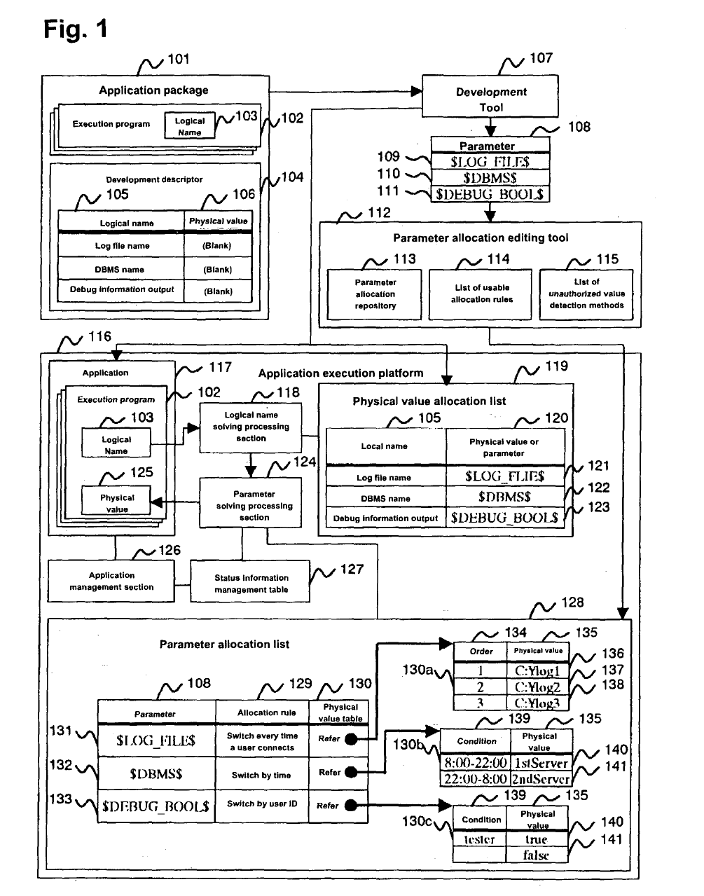

FIG. 1 shows an overall view of an application control according to the present embodiment. As shown in FIG. 1, an information processor according to the present embodiment has a development tool 107, a parameter allocation editing tool 112, a logical name solving processing section 118, a parameter solving processing section 124 and an application management section 126.

The development tool 107 is a processing section that outputs to the parameter allocation editing tool 112 parameters 108, each of which corresponds to a logical name 103 described in an application package 101, and that outputs to an application execution platform 116 an application 117, which includes execution programs 102, and a physical value allocation list 119, which indicates details of a physical value 125 or a parameter 108 allocated to each of the logical names 103.

The parameter allocation editing tool 112 is a processing section that creates a parameter allocation list 128, which indicates allocation rules 129 applicable to the physical values 125 of the parameters 108 that represent a plurality of logical names 103 in the application package 101.

The logical name solving processing section 118 is a processing section that refers to the physical value allocation list 119 to output to the parameter solving processing section 124 a physical value or parameter 120 that corresponds to the logical name 103 in each execution program 102.

The parameter solving processing section 124 is a processing section that, according to the status of the application 117 and the applicable allocation rule 129 in the parameter allocation list 128, allocates one of the physical values 125 to each parameter 108 corresponding to one of the logical names 103 described in the application 117 executed. The application management section 126 is a processing section that obtains status information indicating the execution status of the application 117 and updates a status information management table 127.

Programs that allow the information processor to function as the development tool 107, the parameter allocation editing tool 112, the logical name solving processing section 118, the parameter solving processing section 124 and the application management section 126 are stored on a recording medium such as CD-ROM, stored on a magnetic disk, loaded onto a memory and executed. The memory medium to record the programs may be recording media other than CD-ROM. Furthermore, the programs may be used by having them installed on an information processor from a recording medium, or the programs may be used by accessing the recording medium through a network.

As shown in FIG. 1, the application package 101 contains one or more execution programs 102 and development descriptors 104; each execution program 102 refers to the corresponding logical name 103 when the applicable application is executed; and each development descriptor 104 contains the logical names 105 describing all logical names 103 that the execution program 102 refers to, as well as physical values 106 that each describes a specific value allocated to each of the logical names 105. Since the physical values 106 in the development descriptors 104 vary depending on the execution environment, they are blank.

The development tool 107 is provided as inputs with the application package 101 and the physical values or parameters 120 allocated to the logical names 105; provides as output to the parameter allocation editing tool 112 the parameters 108 to be allocated to the logical names 105; and provides as outputs to the application execution platform 116 the application 117, which includes the execution programs 102 in the application package 101, and the physical value allocation list 119, which indicates the physical values or parameters 120 allocated to the logical names 105.

The parameters 108 in FIG. 1 include, as examples of parameters designated by a user in the development tool 107, $LOG_FILE$ (109) representing a log file name, $DBMS$ (110) representing a database management server name, and $DEBUG_BOOL$ (111) representing the presence or lack of debug information output.

The physical value allocation list 119 in FIG. 1 includes, as examples of physical values or parameters 120 allocated to the logical names 105, a parameter $LOG FILE$ (121) allocated to a logical name “log file name,” a parameter $DBMS$ (122) allocated to a logical name “DBMS name,” and a parameter $DEBUG_BOOL$ (123) allocated to a logical name “debug information output.”

The parameter allocation editing tool 112 is provided with the parameters 108 as an input; refers to a parameter allocation repository 113, which includes information used to automatically create the parameter allocation list 128, a list of usable allocation rules 114, which indicates allocation rules that can be used with specific parameters, and a list of unauthorized value detection methods 115, which includes information indicating unauthorized value detection methods for physical values to be allocated to specific parameters; and provides the parameter allocation list 128 as an output to the application execution platform 116.

The parameter allocation list 128 includes the allocation rules 129 and physical value tables 130, both of which are used to determine the physical values to be allocated to the parameters 108. There are two types of the physical value tables 130 according to the present embodiment: one type that indicates physical values 135 and the order 134 to select the physical values 135, and another type that indicates physical values 135 and terms 139 to determine the physical values 135.

The parameter allocation list 128 in FIG. 1 shows examples of the allocation rules 129 and the physical value tables 130 applicable to the parameters 108. A parameter allocation example 131 indicates that the physical value to be allocated to the parameter $LOG_FILE$ is to be switched in the order of “C: ¥log1” (136), “C: ¥log2” (137) and “C: ¥log3” (138) every time

a

user connects, according to the allocation rule “switch every time a user connects” and a physical value table 130a. A parameter allocation example 132 indicates that the physical value to be allocated to the parameter $DBMS$ is to be switched to “1stServer” when the current time is 8:00 through 22:00 and to “2ndServer” when the current time is 22:00 through 8:00, according to the allocation rule “switch by time” and a physical value table 130b. A parameter allocation example 133 indicates that the physical value to be allocated to the parameter $DEBUG_BOOL$ is to be switched to “true” when the user ID is “tester” and to “false” when the user ID is anything other than “tester,” according to the allocation rule “switch by user ID” and a physical value table 130c.

When the application 117 is executed, each execution program 102 calls the logical name solving processing section 118 to solve the corresponding logical name 103. The logical name solving processing section 118 outputs from the physical value allocation list 119 to the parameter solving processing section 124 the physical value or parameter 120 in the row of the logical name 105 that is equivalent to the logical name 103.

If the physical value or parameter 120 that is input from the logical name solving processing section 118 is among the parameters 108, the parameter solving processing section 124 refers to the status information management table 127, which includes information concerning application execution status, and the parameter allocation list 128, determines the physical value 125 to be allocated to the parameter 108, and sends the physical value 125 determined to the execution program 102. If the physical value or parameter 120 is not among the parameters 108, the parameter solving processing section 124 sends the value as the physical value 125 to the execution program 102.

The application management section 126 updates the status information management table 127 according to the execution status of the application 117.

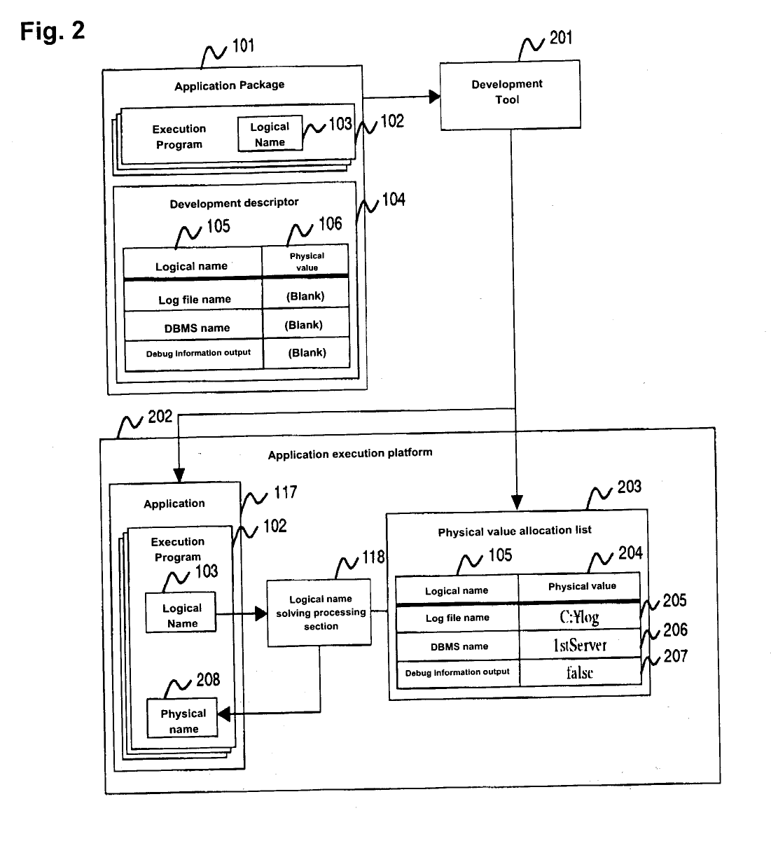

FIG. 2 is an overall view of a conventional application execution platform. A development tool 201 is provided as inputs with an application package 101 and physical values 204 allocated to logical names 105, and provides as an output to an application execution platform 202 a physical value allocation list 203 that includes the physical values 204 to be allocated to the logical names 105.

When an application 117 is executed, each execution program 102 calls a logical name solving processing section 118 to solve a corresponding logical name 103. The logical name solving processing section 118 sends as a physical value 208 to the execution program 102 the physical value 204 in the row of a logical name that is equivalent to the logical name 103 from among the logical names 105 in the physical value allocation list 203.

In “J2EE,” which is a known example of an application execution platform that enhances the reusability of applications, a processing that is equivalent to the logical name solving processing section 118 is called JNDI (Java Naming and Directory Interface) and the physical value allocation list 119 is called a naming context.

As seen in FIGS. 1 and 2, the application package 101 according to the present embodiment is substantially the same as the one used in the conventional technology. In the present embodiment, the reusability of the application package 101 is maintained while applications are controlled by allocating different physical values to each logical name according to allocation rules.

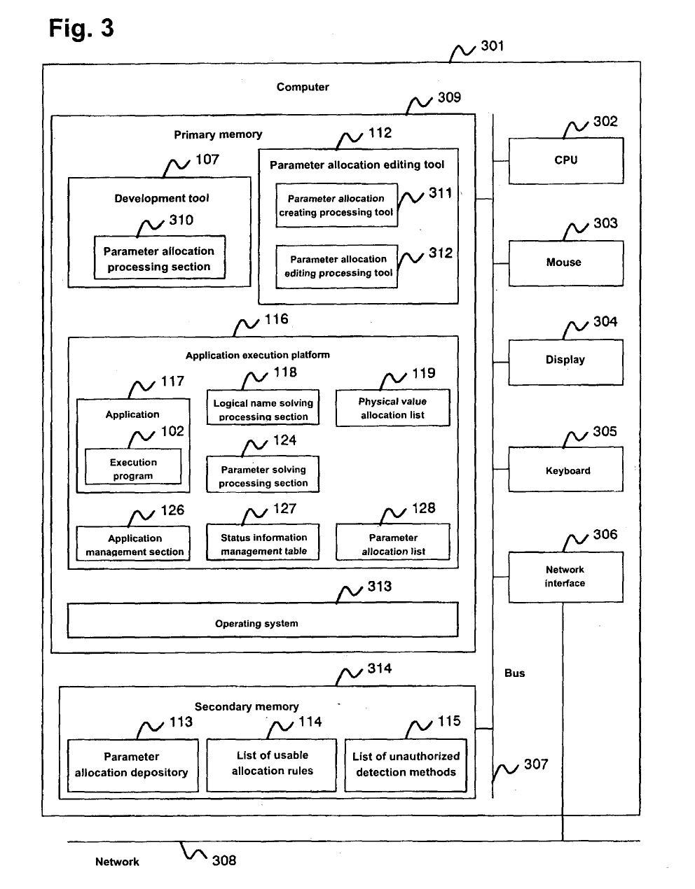

FIG. 3 shows an overall configuration of the information processor that controls applications according to the present embodiment. A computer 301 consists of a CPU 302, a mouse 303, a display 304, a keyboard 305, a network interface 306, a primary memory apparatus 309, a secondary memory apparatus 314, and a bus 307 that mutually connects each component. The computer 301 is connected to a network 308 via the network interface 306.

The primary memory apparatus 309 stores the development tool 107, the parameter allocation editing tool 112, the application execution platform 116 and an operating system 313. The development tool 107 contains a parameter allocation processing section 310, while the parameter allocation editing tool 112 contains a parameter allocation creating processing section 311 and a parameter allocation editing processing section 312. Furthermore, the application execution platform 116 contains the application 117 that includes the execution programs 102, the logical name solving processing section 118, the physical value allocation list 119, the parameter solving processing section 124, the application management section 126, the status information management table 127 and the parameter allocation list 128. One of the development tool 107, the parameter allocation editing tool 112 and the application execution platform 116 may be stored in the primary memory apparatus of another computer connected on the network 308.

The secondary memory apparatus 314 stores the parameter allocation repository 113, the list of usable allocation rules 114 and the list of unauthorized value detection methods 115. The parameter allocation repository 113, the list of usable allocation rules 114 and the list of unauthorized value detection methods 115 may be stored in the secondary memory apparatus of another computer connected on the network 308.

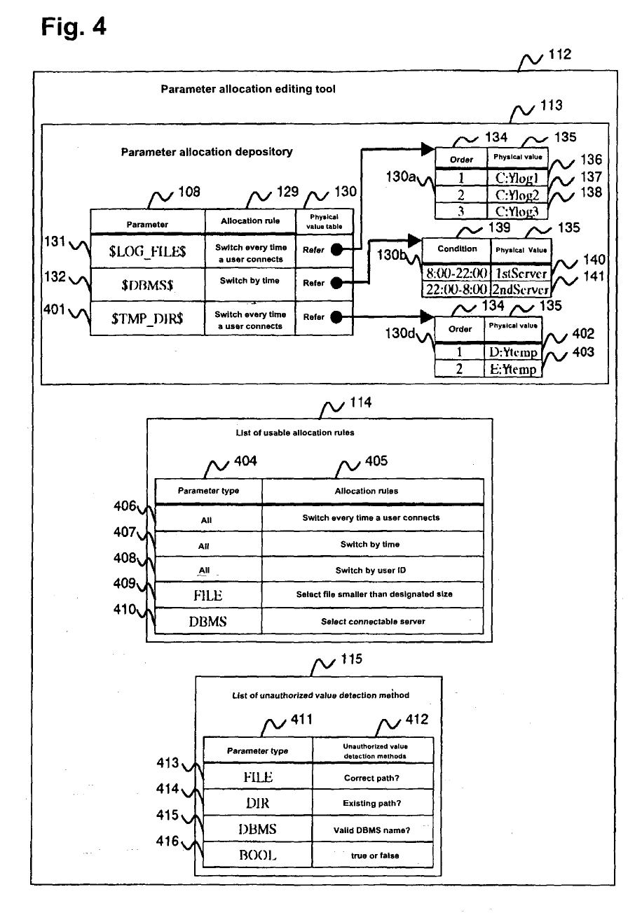

FIG. 4 is an example of the repository and lists of the parameter allocation editing tool 112 according to the present embodiment. The parameter allocation repository 113 can store information with the same structure as that of the information in the parameter allocation list 128. Information that was output in the past by the parameter allocation editing tool 112 and contained in the parameter allocation list 128, as well as information that includes physical values characteristic of each environment, is stored in the parameter allocation repository 113.

FIG. 4 shows an example of information that can be stored in the parameter allocation repository 113. The parameter allocation examples 131 and 132 are the same as the examples shown for the parameter allocation list 128 in FIG. 1. A parameter allocation example 401 indicates that the physical value 135 to be allocated to a parameter $TMP_DIR$ is to be switched every time a user connects in the order of “D: ¥temp” in a physical value example 402 and “E: ¥temp” in a physical value example 403, according to the allocation rule “switch every time a user connects” and a physical value table 130d.

The list of usable allocation rules 114 indicates usable allocation rules 405 for parameters indicated under a parameter type 404.

The parameter type 404 is a set of parameters. For example, when the parameter type 404 is “all,” it indicates all parameters. If the parameter type 404 is a character string other than “all,” it indicates parameters that include the character string in their parameter names. In the latter case, the character string representing the parameter type 404 should be a character string that signifies a type of physical value that can be allocated to the parameter. For example, if the parameter type 404 is “FILE,” this indicates parameters such as $LOG_FILE$ that includes “FILE” in its parameter name, and it signifies that a filename would be allocated as the physical value of the parameter.

For instance, rule examples 406 through 408 indicate allocation rules that can be used with all parameters. A rule example 409 indicates that the allocation rule “select files smaller than designated size” can be used with parameters that include “FILE” in their parameter names. A rule example 410 indicates that the allocation rule “select a server that can be connected” can be used with parameters that include “DBMS” in their parameter names.

The list of unauthorized value detection methods 115 indicates unauthorized value detection methods 412 that detect errors in physical values allocated to parameters designated by parameter types 411. Unauthorized value detection methods range from simple methods that check whether a physical value is a character string expression that follows certain rules, to complicated methods that use a physical value to check whether resources such as files and servers can be accessed in an actual execution environment.

For example, a detection method example 413 indicates that it can determine whether a physical value to be allocated to a parameter that includes “FILE” in its parameter name is incorrect by checking if the physical value represents a valid character string that indicates a file path. A detection method example 414 indicates that it can determine whether a physical value to be allocated to a parameter that includes “DIR” in its parameter name is incorrect by checking if its directory path is a path that actually exists in the execution environment. A detection method example 415 indicates that it can determine whether a physical value to be allocated to a parameter that includes “DBMS” in its parameter name is incorrect by checking if it is a valid DBMS name. A detection method example 416 indicates that it can determine whether a physical value to be allocated to a parameter that includes “BOOL” in its parameter name is incorrect by checking if it is true or false.

We will now describe in detail the parameter allocation processing section 310 that is included in the development tool 107. The parameter allocation processing section 310 of the development tool 107 reads the development descriptors 104 and accepts from users input of the physical values or parameters 120 allocated to the logical names 105. The parameter allocation processing section 310 outputs to the application execution platform 116 the physical value allocation list 119, in which each logical name 105 and the physical value or parameter 120 allocated to it comprise one row. Lastly, the parameter allocation processing section 310 collects all parameters included in the physical values or parameters 120 and outputs the result as the parameters 108 to the parameter allocation editing tool 112.

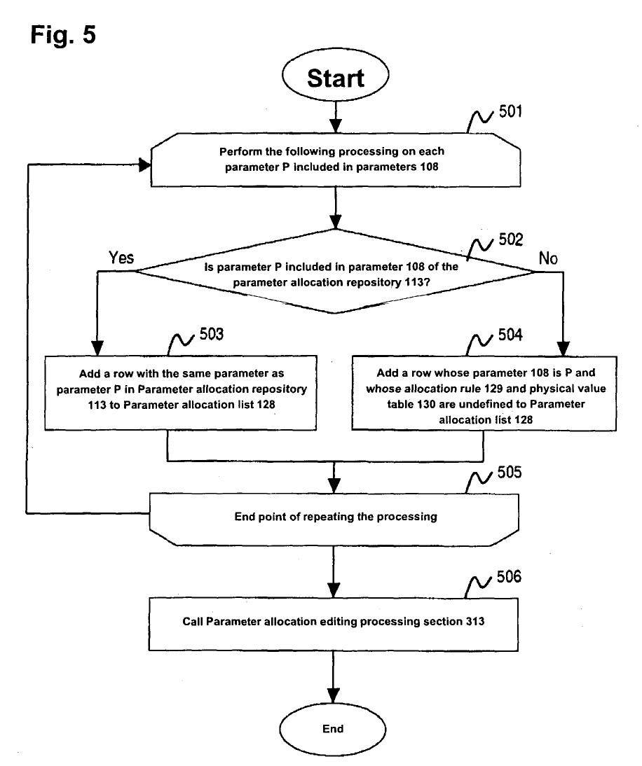

FIG. 5 is a flowchart indicating the processing procedure involved in a processing to create parameter allocation according to the present embodiment. Referring to FIG. 5, the parameter allocation creating processing section 311 that is included in the parameter allocation editing tool 112 is described.

The processing up to step 505 is repeated on each parameter included in the parameters 108 that are output by the parameter allocation processing section 310 of the development tool 107 (step 501). Assuming that each of the parameters included in the parameters 108 is called P, a determination is made as to whether each parameter P is included in parameter 108 of the parameter allocation repository 113 (step 502).

If the parameter P is included in parameter 108 of the parameter allocation repository 113, the allocation rule 129 and the physical value table 130 that are in the row for the parameter allocation example 401 that is equivalent to the parameter P are added to the parameter allocation list 128 (step 503).

If the parameter P is not included in parameter 108 of the parameter allocation repository 113, a row, whose parameter 108 is P and whose allocation rule 129 and physical value table 130 are undefined, is added to the parameter allocation list 128 (step 504).

When step 501 through step 505 are repeated for all parameters, the parameter allocation editing processing section 312 is called (step 506).

Due to the fact that the parameter allocation creating processing section 311 creates the parameter allocation list 128 using information included in the parameter allocation repository 113, errors that may be caused by users' errors in inputting physical values can be prevented when applications are executed.

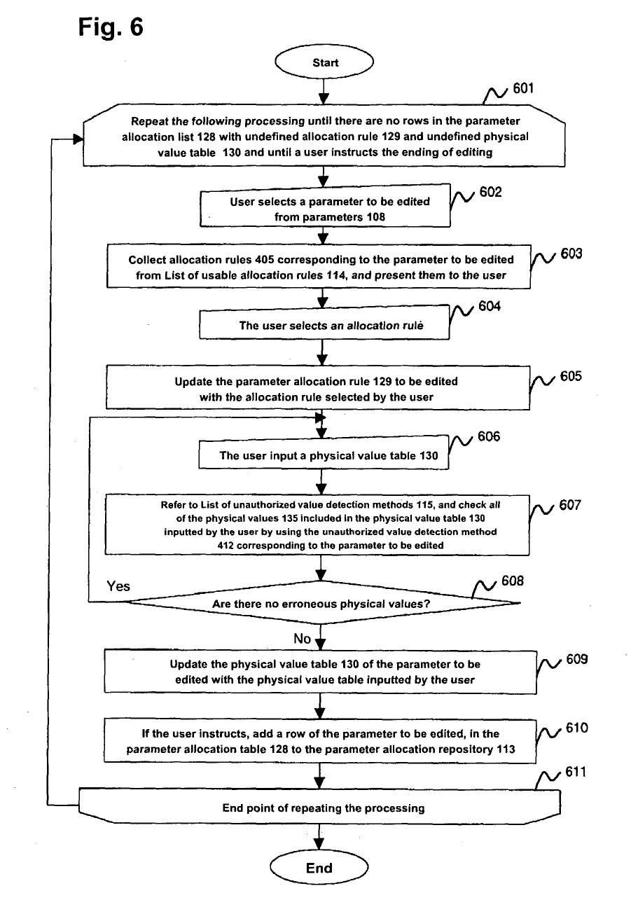

FIG. 6 is a flowchart indicating the processing procedure for a parameter allocation editing processing according to the present embodiment. Referring to FIG. 6, the processing of the parameter allocation editing processing section 312.

The parameter allocation editing processing section 312 repeats the processing from step 601 through step 611 until there are no rows in the parameter allocation list 128 with undefined allocation rule 129 and undefined physical value table 130, and until a user instructs the end of editing (step 601).

The parameters 108 are presented to the user and the user selects a parameter to edit (step 602). Hereinafter, the parameter to be edited is called P.

Rows whose parameter type 404 is “all,” as well as the allocation rule 405 of each row in which the character string of the parameter type 404 is included in the name of the parameter P, are collected from the list of usable allocation rules 114, and the result is presented to the user (step 603).

The user selects an allocation rule from among the allocation rules presented to determine the physical value to be allocated to the parameter P (step 604).

The allocation rule 129 in the row in which one of the parameters 108 of the parameter allocation table 128 matches the parameter P is updated to the allocation rule selected by the user in step 604 (step 605).

If the user were to directly edit the allocation rule 129 in the parameter allocation list 128, the user may designate an allocation rule that cannot be used with the parameter P. Step 603 through step 605 can prevent updating the parameter allocation list 128 to any allocation rules that cannot be used with the parameter P.

Next, the user inputs one of the physical value tables 130 consisting of the physical value 135 and the order 134 or the terms 139 (step 606).

The list of unauthorized value detection methods 115 is referred to and the unauthorized value detection method 412 in the row in which the character string of the parameter type 411 is included in the parameter P is referred to. Using the unauthorized value detection method 412, all of the physical values 135 that are input by the user in step 606 are checked for erroneous physical values (step 607).

If there is even one erroneous physical value when the physical values 135 are checked in step 607, it is notified to the user and the processing returns to step 606. If there are no erroneous physical values, the processing proceeds to step 609 (step 608).

Any erroneous physical values input by the user can be detected in step 607 and step 608 before the application is executed, thereby preventing errors when the application is executed.

The physical value table 130 in the row in which one of the parameters 108 of the parameter allocation table 128 matches the parameter P is updated to the physical value table input by the user in step 606 (step 609).

If the user instructs, a row in the parameter allocation table 128 that contains the parameter 108 that matches the parameter P, the corresponding allocation rule 129 and the corresponding physical value table 130, is added to the parameter allocation repository 113 (step 609). If the parameter 108 that matches the parameter P already exists in the parameter allocation repository 113, the row is not added to the parameter allocation repository 113. Instead, the row of the parameter 108 that matches the parameter P in the parameter allocation repository 113 is updated to the contents of the allocation rule 129 and the physical value table 130 in the row in which the parameter 108 of the parameter allocation list 128 matches the parameter P.

When step 601 through step 611 is repeated as necessary, the parameter allocation editing processing section 312 is terminated.

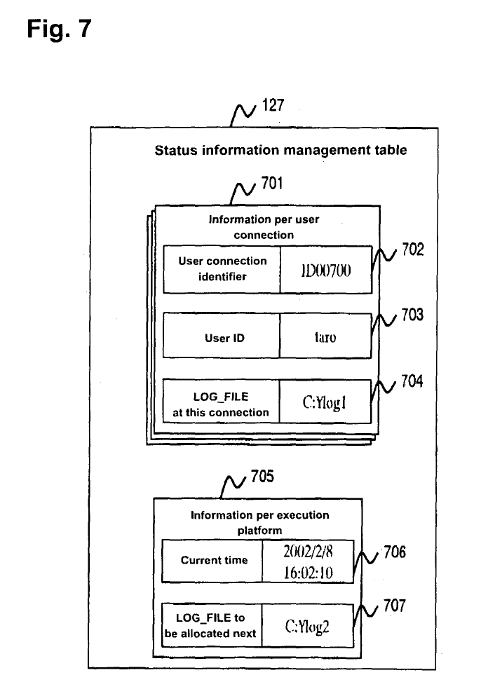

FIG. 7 is an example of the status information management table 127 according to the present embodiment. In FIG. 7, the status information management table 127 used by the parameter solving processing section 124 is shown in detail.

Information per user connection 701 is prepared for the status information management table 127 every time a user connects to the application 117. In FIG. 7, a user connection identifier 702, which is a session ID assigned every time a user connects, a user ID 703, which is an ID of the user connecting, and a LOG_FILE 704, which indicates a physical value allocated to the applicable user connection when the physical value allocated to the parameter $LOG_FILE$ is switched every time a user connects, are indicated as examples of information included in the information per user connection 701.

In addition, information per execution platform 705 that is prepared on a one-to-one basis for each application execution platform is included in the status information management table 127. In FIG. 7, a current time 706 and a LOG_FILE 707, which indicates a physical value that is to be allocated to the next user connection when the physical value allocated to the parameter $LOG_FILE$ is switched every time a user connects, are indicated as examples of information included in the information per execution platform 705.

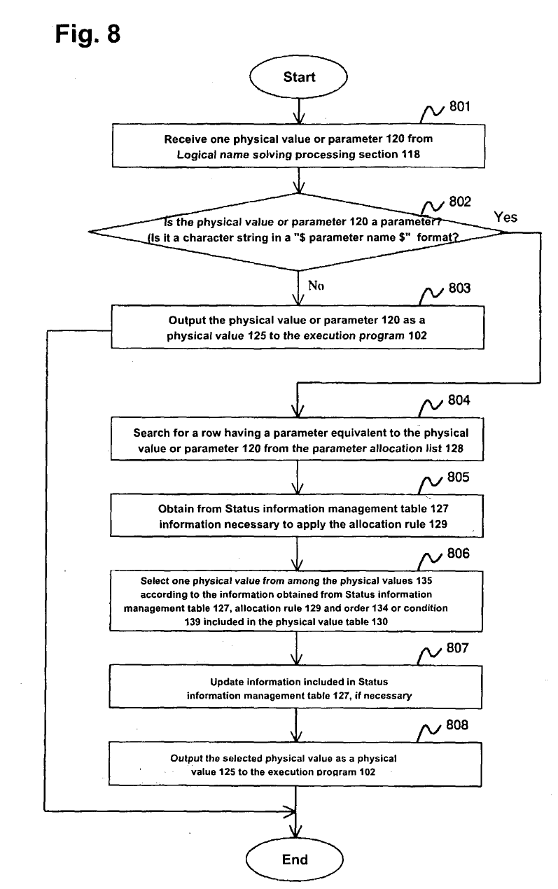

FIG. 8 is a flowchart indicating the processing procedure for a parameter solving processing according to the present embodiment. Referring to FIG. 8, the parameter solving processing section 124 of the application execution platform 116 is described.

The parameter solving processing section 124 first receives one physical value or parameter 120 from the logical name solving processing section 118 (step 801).

Whether the physical value or parameter 120 received is a parameter, i.e., a character string in a “$ parameter name $” format, is determined (step 802). If the physical value or parameter 120 is not a parameter, the processing proceeds to step 803; if it is a parameter, the processing proceeds to step 804.

In step 803, the physical value or parameter 120 is output as the physical value 125 to the execution program 102, and the parameter solving processing section 124 is terminated.

If the physical value or parameter 120 is found to be a parameter in step 802, a row having a parameter equivalent to the parameter in question is searched for in the parameter allocation list 128. In the subsequent processing, the allocation rule 129 and the physical value table 130 in the row in question become subjects of the processing (step 804).

Information concerning status required to apply the allocation rule 129 is obtained from the status information management table 127 (step 805). For example, if the allocation rule 129 is “switch by time,” the current time 706 is obtained from the status information management table 127 as required information.

One physical value is selected from among the physical values 135 based on the information obtained in step 805, the allocation rule 129 and the order 134 or the terms 139 that the physical value table 130 refers to (step 806). For example, if the parameter 108 is $DBMS$ as in the parameter allocation example 132, the allocation rule 129 is “switch by time”; accordingly, the current time 706 obtained is referred to, and if the current time 706 is between 8:00 and 22:00, “1stServer” is selected as the physical value in accordance with the terms 139 of the physical value example 140.

If necessary, information contained in the status information management table 127 is updated (step 807). For example, when the physical value allocated to the parameter $LOG_FILE$ is switched every time a user connects as indicated in the parameter allocation example 131 of the parameter allocation list 128, a physical value that is allocated to a user connection is stored as the LOG_FILE 704 for that particular connection. By doing this, the same physical value is always allocated to the parameter $LOG_FILE$ in the execution program 102 that performs the processing in the user connection in question. Further, to avoid allocating to a different user connection a physical value already allocated to a particular user connection, the physical value 135 that corresponds to the next order 134 is stored as the LOG_FILE 707 to be allocated next. If there is no physical value 135 for the next order 134, the next order 134 becomes “1.” To solve the parameter $LOG_FILE$ in step 806, the LOG_FILE 704 for the current connection and the LOG_FILE 707 to be allocated next are obtained as required information.

The physical value selected in step 806 is output as the physical value 125 to the execution program 102 (step 808), and the parameter solving processing section 124 is terminated.

As described above, according to the present embodiment, due to the fact that different physical values are allocated to each logical name according to application execution status and allocation rules, applications that switch physical values depending on the status can be realized without having to include in the application a processing to switch the physical value depending on the execution status. As a result, by modifying the parameter allocation list 128 to match the environment, applications can be reused even in environments with different status for switching physical values or with different physical values to be allocated. Furthermore, according to the present embodiment, due to the fact that unauthorized physical values are detected according to the list of unauthorized value detection methods 115, errors that occur when applications are executed and that are caused by erroneous physical values allocated to logical names can be prevented.

In the application control method according to the present invention, instead of using parameters, a physical value allocation list that includes logical names, allocation rules to determine physical values to be allocated to the logical names, and physical values that are allocatable according to the allocation rules can be used to control applications.

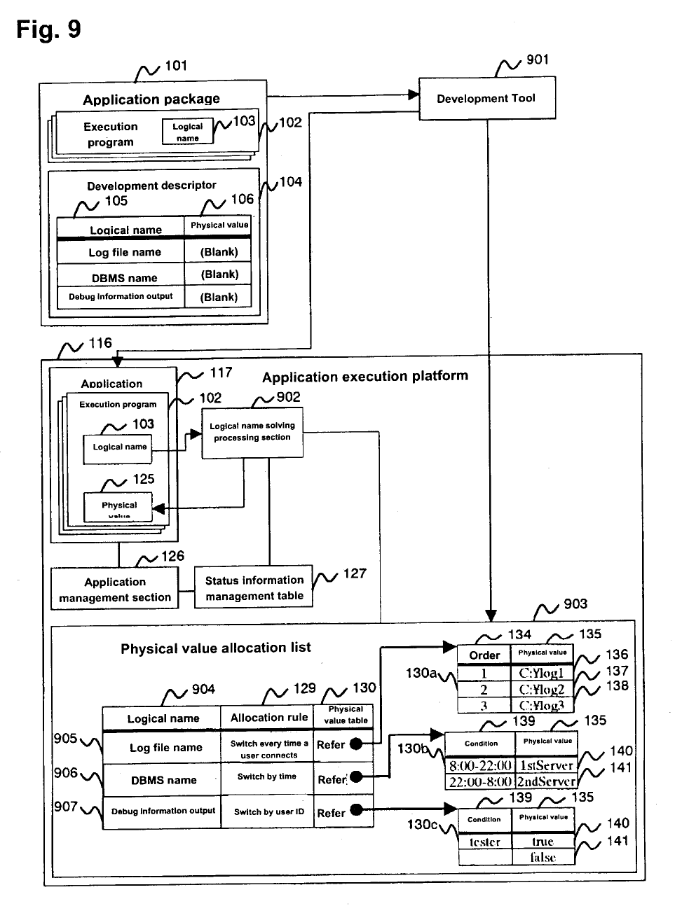

FIG. 9 shows an overall configuration of an application control that does not use parameters, in accordance with another embodiment of the present invention. An information processor according to the present embodiment shown in FIG. 9 has a development tool 901 and a logical name solving processing section 902.

The development tool 901 is a processing section that outputs to an application execution platform 116 an application 117, which includes execution programs 102, and a physical value allocation list 903, which indicates allocation rules 129 for physical values 125 corresponding to logical names 103 described in an application package 101.

The logical name solving processing section 902 is a processing section that, according to application status and the allocation rules 129 in the physical value allocation list 903, allocates physical values 125 to the logical names 103 described in the application 117 executed.

A program that allows the information processor to function as the development tool 901 and the logical name solving processing section 902 is recorded on a recording medium such as CD-ROM, stored on a magnetic disk, loaded onto a memory and executed. The memory medium to record the program on may be recording media other than CD-ROM. Furthermore, the program may be used by having it installed on an information processor from a recording medium, or the program may be used by accessing the recording medium through a network.

The development tool 901 outputs the physical value allocation list 903 when an application execution environment is constructed. When an application is executed, the logical name solving processing section 902 refers to the allocation rule 129 and a physical value table 130 in the row of a logical name 904 whose name is equivalent to the logical name 103 in the execution program 102, as well as to a status information management table 127, and determines the physical value 125 to output to the application depending on the status.

As described above, in the present embodiment, by using the physical value allocation list 903 that includes the logical names 904, the allocation rules 129 and the physical value tables 130, different physical values can be allocated to one logical name without using parameters to control applications.

The above embodiments describe the allocation of physical values to logical names in a general application execution environment, but the logical names and physical values can be environment entry names and environment entry values, respectively, so that environment entry values are allocated to environment entry names in J2EE platforms.

As described above, in information processors according to the present embodiment, due to the fact that operations of applications are controlled by allocating physical values to logical names according to application status and predetermined allocation rules, applications that switch physical values depending on the execution status can be made reusable in different execution environments.

According to the present invention, due to the fact that operations of applications are controlled by allocating physical values to logical names according to application status and predetermined allocation rules, applications that switch physical values depending on the execution status can be made reusable in different execution environments.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An application control method to control operations of an application by solving logical names described by development descriptors, the method comprising the steps of:
creating an allocation list that indicates allocation rules to allocate physical values to the logical names described in the application; and
allocating physical values to the logical names described in the application being executed according to an application status and the allocation rules in the allocation list.

2. An application control method according to claim 1, further comprising the step of referring to a repository that indicates allocation rules used in a previous processing for creating the allocation list.

3. An application control method according to claim 1, further comprising the step of, upon creating the allocation list, referring to an allocation list that indicates usable allocation rules to present usable allocation rules.

4. An application control method according to claim 1, further comprising the step of referring to a list of unauthorized value detection methods representative of information for detecting unauthorized physical values, and detecting an error in the physical values.

5. An application control method according to claim 1, wherein the logical names and the physical values are environment entry names and environment entry values, respectively, and the environment entry values are allocated to the environment entry names on a Java execution platform.

6. An application control method according to claim 1, wherein a parameter allocation list that indicates allocation rules to allocate parameters representative of a plurality of logical names to physical values is created as the allocation list, and physical values are allocated to parameters corresponding to the logical names described in the application being executed according to an application status and the allocation rules in the parameter allocation list.

7. An application control method according to claim 6, further comprising the step of referring to a repository that indicates allocation rules used in a previous processing for creating the allocation list.

8. An application control method according to claim 6, further comprising the step of, upon creating the allocation list, referring to an allocation list that indicates usable allocation rules to present usable allocation rules.

9. An application control method according to claim 6, further comprising the step of referring to a list of unauthorized value detection methods representative of information for detecting unauthorized physical values, and detecting an error in the physical values.

10. An application control method according to claim 6, wherein the logical names and the physical values are environment entry names and environment entry values, respectively, and the environment entry values are allocated to the environment entry names on a Java execution platform.

11. An information processor that controls operations of an application by solving logical names described by development descriptors, the information processor comprising:
a parameter allocation editing tool that creates a parameter allocation list that indicates allocation rules to allocate parameters representative of a plurality of logical names described in the application to physical values; and
a parameter solving processing section that allocates physical values to parameters corresponding to logical names described in the application being executed according to an application status and the allocation rules in the parameter allocation list.

12. An information processor according to claim 11, further comprising a repository that indicates allocation rules used in a previous processing, wherein the parameter allocation list is created by referring to the repository.

13. An information processor according to claim 11, further comprising a usable allocation rule list that indicates usable allocation rules, wherein, upon creating the allocation list, the usable allocation rule list is referred to present usable allocation rules.

14. An information processor according to claim 11, further comprising a list of unauthorized value detection methods representative of information for detecting unauthorized physical values, wherein the list of unauthorized value detection methods is referred to detect an error in the physical values.

15. An information processor that controls operations of an application by solving logical names described by development descriptors, the information processor comprising:
a development tool that creates an allocation list that indicates allocation rules to allocate physical values to the logical names described in the application; and
a logical name solving processing section that allocates physical values to the logical name described in the application being executed according to an application status and the allocation rules in the allocation list.

16. An information processor according to claim 15, further comprising a repository that indicates allocation rules used in a previous processing, wherein the allocation list is created by referring to the repository.

17. An information processor according to claim 15, further comprising a usable allocation rule list that indicates usable allocation rules, wherein, upon creating the allocation list, the usable allocation rule list is referred to present usable allocation rules.

18. An information processor according to claim 15, further comprising a list of unauthorized value detection methods representative of information for detecting unauthorized physical values, wherein the list of unauthorized value detection methods is referred to detect an error in the physical values.

19. A program that renders a computer to function as an information processing unit that controls operations of an application by solving logical names described by development descriptors, wherein the program renders the computer to function as:
a parameter allocation editing tool that creates a parameter allocation list that indicates allocation rules to allocate parameters representative of a plurality of logical names described in the application to physical values; and
a parameter solving processing section that allocates physical values to parameters corresponding to logical names described in the application being executed according to an application status and the allocation rules in the parameter allocation list.

20. A program that renders a computer to function as an information processor that controls operations of an application by solving logical names described by development descriptors, wherein the program renders the computer to function as:
a development tool that creates an allocation list that indicates allocation rules to allocate physical values to the logical names described in the application; and
a logical name solving processing section that allocates physical values to the logical name described in the application being executed according to an application status and the allocation rules in the allocation list.
